(19) United States
(12) Patent Application Publication
(10) Pub. No.: US 2010/0039393 A1
(43) Pub. Date: Feb. 18, 2010

(54) TEXT ENTRY ON TOUCH SCREEN CELLPHONES BY DIFFERENT PRESSURE LEVELS

(75) Inventors: James Pratt, Round Rock, TX (US); Sarah Everett, Austin, TX (US); Marc Sullivan, Austin, TX (US)

Correspondence Address: AT&T Legal Department - T&W;Attn: Patent Docketing, Room 2A-207, One AT&T Way, Bedminster, NJ, 07921, US

(73) Assignee: AT&T Intellectual Property I, L.P., Reno, NV (US)

(21) Appl. No.: 12/192,662

(22) Filed: Aug. 15, 2008

(51) Int. Cl. G06F 3/041

(52) U.S. Cl. 345/173

(57) ABSTRACT

A system and methodology that can enter different text based on an amount of pressure exerted on a key of an electronic device is provided. The system employs one or more sensors located on the key to collect pressure data. A pressure detection component selects text associated with the currently applied pressure. A user can modify the selected text by adjusting the pressure applied to the key. Once the desired text is selected, the user releases pressure from the key and a text entry component enters the selected text.

### BACKGROUND

Mobile communication technology is rapidly advancing the exchange of information between users and systems. The user is no longer tied to a stationary device such as a personal computer in order to communicate with another user, listen to music, or watch a video. Further, portable phones (and other portable devices) can be utilized as full-service computing machines. Portable wireless devices such as cell phones and PDAs (personal digital assistants) are being extensively used for most any application and user-interaction with the device is rapidly evolving.

Various audio/visual techniques, including touch screens, are employed to facilitate user-interaction with an electronic device, such as cellular phones, media players, navigation systems, ATMs (Automated Teller Machine), tablet PCs (personal computers), etc. Device designers are on the lookout for new techniques that make devices more user-friendly and receptive to the user's needs.

Human Computer Interaction (HCI) is aimed at understanding the interaction between humans and computer interfaces to make improvements in devices, such that they are easier to use. Computer interface technology is changing rapidly, offering new interaction possibilities to which previous research findings may not apply. Newer devices are substantially smaller and have lesser area for user interaction. Typically, on compact devices, Triple Tap techniques are employed for text entry to expand the keypad. However, these methods are slow and cumbersome, and can lead to user frustration.

The use of text messaging for communication has been on the rise and is one of the most widely used data services on cellular phones. Cellular phone subscribers send billions of messages each day by employing a wide range of devices. Conventional cellular phones that have traditional number keypads employ triple-tap text entry or predictive text entry. Pressure sensitive touch screen phones that have small screens, cannot display full keyboards and employ similar methods to expand keys. Triple tap and/or predictive text entry is not limited to cellular phones, but can be employed in any other electronic device to expand the set of physical keys. However, these conventional methods are slow, potentially confusing and thus not very user friendly.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

The systems and methods disclosed herein, in one aspect thereof, can facilitate text entry on an electronic device based on pressure exerted by a user on a key. The system provides a simple, fast, and easy-to-use technique to select between multiple options associated with a key. According to an aspect, the system includes a pressure detection component, which receives data associated with pressure applied on a key, from one or more sensors. The pressure detection component can monitor changes in pressure applied by the user and accordingly update the selected text. Further, the pressure detection component can detect when pressure is released from the key. A release in pressure can indicate that the currently selected text can be entered.

In accordance with another aspect of the system, a text entry component can be employed to enter the selected text into the device. As an example, the text entry component can enter the selected text by displaying the text on a display screen. Additionally or alternately, the text entry component can perform an action based in part on the selected text.

Another aspect of the subject innovation comprises a display component that can display the selected text to a user, for example, via a display screen or monitor. The display component can update the displayed text when pressure applied to the key is changed. Further, the display component can display the currently selected text along with one or more text entry options that can be selected by the user on changing the applied pressure. Thus, a user can easily identify the desired text entry option and accordingly increase or decrease the applied pressure. Furthermore, the display component can highlight the currently selected option and/or differentiate the current selection from the available text entry options.

Still another aspect of the system comprises an initialization component that can be employed to perform an initial setup that customizes pressure thresholds for a particular user. Typically, characters associated with a key can be assigned a range of pressure values, which can be specified by a user via the initialization component. Moreover, the initialization component can receive one or more explicit threshold values for each character from a user. Additionally or alternately, the initialization component can request the user to press a key with a maximum pressure and/or with a minimum pressure and can interpolate pressure threshold values (or ranges) for each character associated with the key.

Yet another aspect of the disclosed subject matter relates to a method that can be employed to select text based on pressure data collected by one or more sensors. Specifically, the pressure exerted on the key can be determined based on data collected by one or more pressure sensors. Based on the determined pressure, a text entry can be selected. Typically, the received pressure data can be analyzed and compared to one or more predetermined pressure thresholds. According to an aspect, if the determined pressure lies within a range specified by the predetermined threshold, a particular character(s) assigned to the range can be selected. The selected text can be displayed to the user, such that, the user can adjust pressure applied to the key until a desired text entry is selected. Based on the change in applied pressure the currently selected text can be modified. When the user is satisfied with the currently selected text, the user can release pressure from the key and the currently selected text can be entered.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example system that can facilitate text entry based on contact pressure, according to an aspect of the subject specification.

FIG. 2 illustrates an example system that can be employed to monitor pressure exerted by a user utilizing an electronic device in accordance with the disclosure.

FIG. 3 illustrates an example system that can be employed to display text associated with a pressure level, on an electronic device in accordance with an aspect of the disclosure.

FIG. 4 illustrates an example system that can select between different options based on the amount of pressure exerted on a sensor located on an electronic device, according to an aspect of the subject innovation.

FIG. 5 illustrates an example system that can facilitate automating one or more features by employing machine learning techniques in accordance with the subject innovation.

FIG. 6 illustrates an example electronic device that can employ pressure analysis for text entry in accordance with an aspect of the disclosed subject matter.

FIG. 7 illustrates an example display that can be employed to view a current selection based on the applied pressure, according to an aspect of the disclosed subject innovation.

FIG. 8 illustrates an example display that can be employed to view a currently selected option based on pressure applied to a key in accordance with an aspect of the disclosed subject innovation

FIG. 9 illustrates an example methodology that can be employed to facilitate text entry based on an amount of pressure applied to a key on an electronic device in accordance with an aspect of the subject innovation.

FIG. 10 illustrates an example methodology that can facilitate selection of text based on the pressure data collected by one or more sensors in accordance with an aspect of the system.

FIG. 11 illustrates an example methodology that can be employed to customize pressure thresholds for a particular user, according to an aspect of the disclosed subject innovation.

FIG. 12 illustrates a schematic block diagram of a computing environment that facilitates text entry with different pressure levels in accordance with the subject specification.

FIG. 13 illustrates is a schematic block diagram depicting of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Inference can also refer to techniques employed for composing higher-level events from a set of events or data. Such inference can result in the construction of new events or actions from a set of observed events and/or stored event data, whether or not the events are correlated in close temporal proximity, and whether the events and data come from one or several event and data sources. Various classification schemes and/or systems (for example, support vector machines, neural networks, expert systems, Bayesian belief networks, fuzzy logic, data fusion engines, or other similar systems) can be employed in connection with performing automatic and/or inferred actions.

Furthermore, various embodiments are described herein in connection with an electronic device that employs a touch screen. An electronic device can also be called a system, subscriber unit, subscriber station, mobile station, mobile, remote station, remote terminal, access terminal, user terminal, terminal, wireless communication device, user agent, user device, or user equipment (UE). The terms “electronic device”, “device”, “system” are used interchangeably herein and are intended to refer to most any electronic device such as, but not limited to a cellular telephone, a cordless telephone, a Session Initiation Protocol (SIP) phone, a wireless local loop (WLL) station, a personal digital assistant (PDA), a handheld electronic device, a laptop, an automated teller machine (ATM), a computing device, a media player, a media recorder, a camera, etc., or a combination thereof.

As the size of electronic devices is reducing, the amount of space available for a key has also reduced. Conventional systems employ triple-tap or predictive technologies to select multiple options with a single key. Pressure-sensitive touch screen are also being employed, for example in cellular phones, but as the size of the screen is reduced, a full keyboard cannot be displayed on the screen.

Systems and/or methods are presented herein that can facilitate text entry on an electronic device that employs a reduced set of keys. The system provides a simple and fast technique to enter text on, for example, a phone with a small touch screen, without employing a slow triple tap and/or potentially confusing predictive text technique. The text entry is based on the amount of pressure applied by a user, for example on the touch screen. As an example, if a key and/or button represented the letters ‘A’, ‘B’, and ‘C’, a light touch on the key and/or button can select letter ‘A’, a slightly harder touch can select letter ‘B’ and a firm touch can select letter ‘C’. Once the desired letter is selected, the user can release pressure and the letter can be typed on the screen.

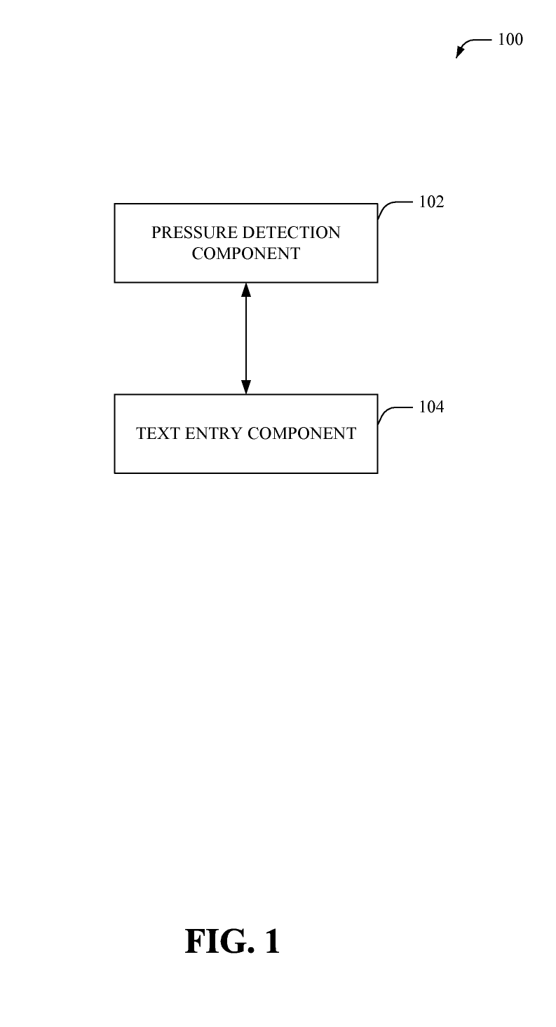

Referring initially to FIG. 1, there illustrated is an example system 100 that can facilitate text entry based on contact pressure, according to an aspect of the subject specification. The text entry can be employed to enter text to most any electronic device (not shown), such as, but not limited to a cellular phone, a global positioning system (GPS) navigator, a personal digital assistant (PDA), a laptop, an ATM, a jukebox, a multimedia kiosk etc. The electronic device can include a keypad with one or more physical keys and/or can employ a touch screen to enter data.

The system 100 can typically include a pressure detection component 102 that can be employed to determine the amount of pressure applied to a sensor by a user. It can be appreciated that the user can employ most any apparatus, such as, but not limited to, a stylus or a finger to apply pressure. Further, the user can apply pressure on a touch screen, a key and/or a dedicated area on the device employed for text entry and/or selection.

The pressure detection component 102 can monitor changes in pressure applied by the user. An increase or decrease in pressure can change the selected text. Further, the pressure detection component 102 can also detect when pressure is released. A release in pressure can indicate that the currently selected text can be entered.

The pressure detection component 102 can receive data associated with a force exerted by a user, from one or more sensors (not shown). Typically, the sensors can be located most anywhere on the electronic device, for example on a key or touch screen. The pressure detection component 102 can analyze the received pressure information and compare it with a predefined pressure threshold. According to an aspect, if the received pressure is greater than the predefined pressure threshold, a particular character can be selected; else, another character can be selected. As an example, the predefined threshold can be specified by the device manufacturer, customized by a user or automatically determined. Further, it can be appreciated that one or more thresholds can be specified based on the number of characters assigned to the key.

The selected character and/or text can be sent to a text entry component 104 that can be employed to enter the selected text into the device. According to an aspect, the text entry component 104 can enter the selected text by displaying the text on a display screen. Additionally or alternately, the text entry component 104 can perform an action based in part on the selected text. As an example, a user can touch a touch screen on an ATM to indicate a cash withdrawal. The user can adjust the pressure applied on the screen until the cash withdrawal option is selected. The text entry component 104 can then dispense cash to the user based on the user's selection.

In yet another example, a user can enter text on a cellular phone by adjusting the force on a pressure sensor that is typically located on a key or a touch screen. The pressure detection component 102 can determine the amount of pressure received and can select a character associated with the received pressure value. Typically, each character can be associated with a range of pressure values. If the received pressure value lies within the range, a character assigned to the range can be selected, for example, by the pressure detection component 102. When the user changes the pressure on the pressure sensor, the pressure detection component 102 can accordingly change the selected character. The pressure detection component 102 can further detect when the user releases pressure and can send the currently selected character to the text entry component 104. The text entry component 104 can enter the selected character and/or display the selected character on a screen.

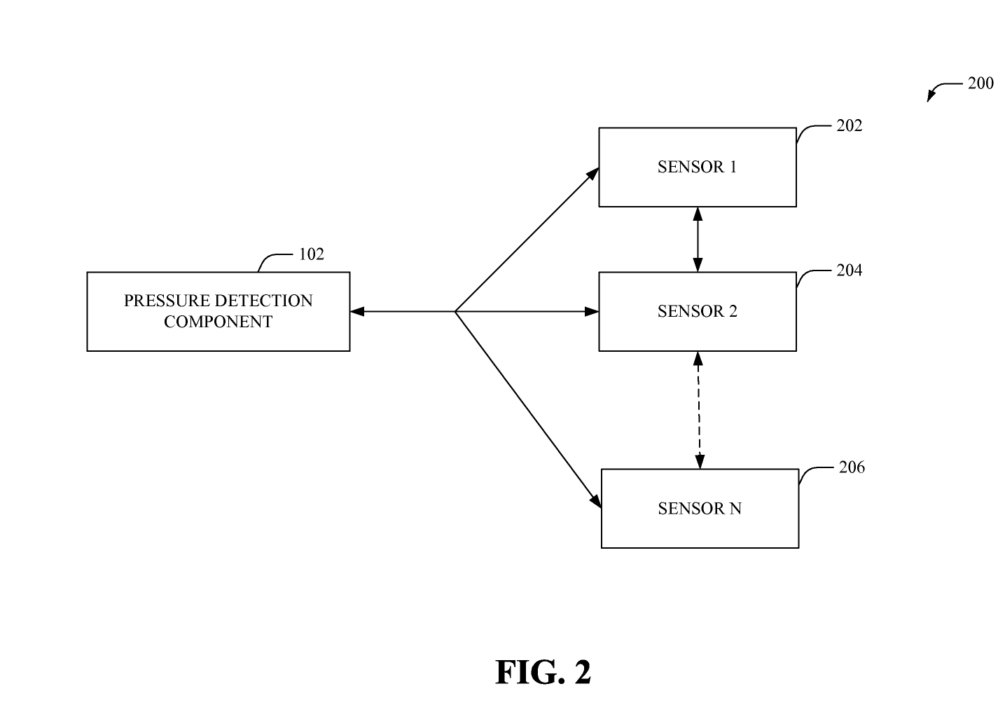

Referring now to FIG. 2, there illustrated is an example system 200 that can be employed to monitor pressure exerted by a user utilizing an electronic device in accordance with the disclosure. The electronic device can include, but is not limited to, a mobile phone, an MP3 player, a GPS navigator, a PDA, a gaming module, a radio player, a media recorder, an ATM, a self-service kiosk, or a combination thereof. It can be appreciated that the pressure detection component 102 can include functionality, as more fully described herein, for example, with regard to system 100.

As seen from FIG. 2, the pressure detection component 102 can be connected to multiple sensors (202-204). It can be appreciated that although only three sensors are depicted in the figure, one or more sensors can be employed to sense pressure. The sensors, sensor 1 to sensor N (where N can be a natural number from one to infinity) can be employed to collect data that identifies the pressure associated with a user's touch on the sensor. When a user is interacting with a device, the user can typically touch the keys and/or the touch-screen display on the device, for example to enter text. Thus, the sensors (202-204) can preferably be located on the keys and/or the display. It can be appreciated that the sensors (202-204) can be placed anywhere on the electronic device in a manner that is transparent to the user. Additionally or alternately, the sensors (202-204) can be located in a dedicated area that is visible to the user. As an example, “Touch here to select”, “Options”, “yes/no”, “A, B, C . . . ” or the like can be written over the dedicated area, such that the user can easily identify where to touch the device in order to make a selection and/or enter text.

The sensors (202-204) can employ most any pressure sensing technology including, but not limited to, fiber optic, semiconductor piezoresistive, microelectromechanical systems (MEMS), vibrating elements (silicon resonance, for example), variable capacitance, mechanical deflection, or strain gauge sensors, and/or a combination thereof. According to one aspect, sensors (202-204) can include fiber optic sensors that sense pressure by constructing miniaturized fiber optic interferometers to sense a nanometer scale displacement of membranes. According to another aspect, sensors (202-204) can include semiconductor piezoresistive sensors that employ the change in conductivity of semiconductors due to the change in pressure, to determine pressure applied. Further, one or more sensors (202-204) can employ MEMS technology. Typically, MEMS sensors measure pressure by combining microelectronics with tiny mechanical systems such as valves, gears, and any other mechanical systems all on one semiconductor chip using nanotechnology.

The sensors (202-204) can also compute pressure based on the change in vibration on a molecular level of the different material elements due to change in pressure. Additionally or alternately, sensors (202-204) can calculate pressure based on change of capacitance due to change of the distance between the plates of a capacitor because of change in pressure.

The pressure detection component 102 can receive the data collected by sensors (202-204) associated with the pressure exerted by a user. The pressure detection component 102 can analyze the received data and additionally employ techniques that avoid errors associated with false reads. In addition, the pressure detection component 102 can also aggregate data received from multiple sensors (202-204) to determine text that can be selected.

As an example, a MP3 (MPEG-1 Audio Layer 3) player, with a reduced set of keys, can employ the system 200 to facilitate selection of a song. According to an aspect, a user can scroll through a list of songs by employing a single key. Conventional systems employ a technique wherein a user can press a key/button multiple times to select a song from a list. However as the list increases in size, this technique is tedious, slow and can lead to user frustration. Further, when employing a single key, the user will have to go through the entire list to scroll back in the list. Thus, conventional techniques facilitate scrolling (or selection) in one direction by employing a key. The subject system, however, can enable the user to scroll forward or backward by adjusting pressure applied to the key. Referring back to the example, the user can exert pressure on a sensor (202-204) that can be placed on a key of the MP3 player. The pressure detection component 102 can determine the amount of pressure applied by the user and select an option associated with the applied pressure, for example a song, from a list. Further, the pressure detection component 102 can detect a change in applied pressure and accordingly change the selected option. In particular, a decrease in applied pressure can select a previous option while an increase in applied pressure can select the next option in the list. When the user is satisfied with the selection, the user can release the applied pressure. The pressure detection component 102 can sense the release of pressure based on the data received from the sensors (202-204) and send the selected option (e.g. song) to a text entry component (FIG. 1, 104).

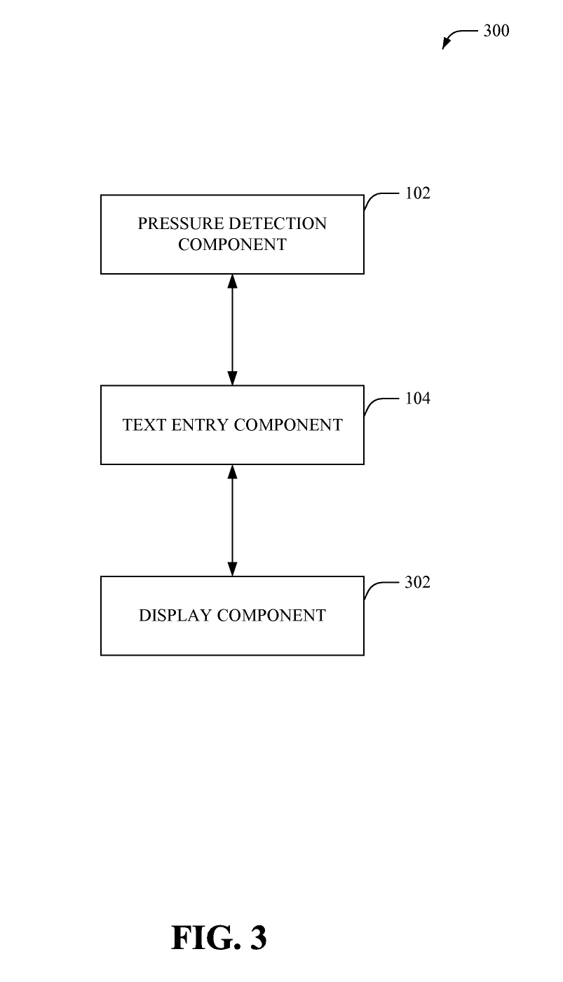

FIG. 3 illustrates an example system 300 that can be employed to display text associated with a pressure level on an electronic device in accordance with an aspect of the disclosure. The electronic device can be a cell phone, media player, camera, media recorder, electronic kiosk, ATM, etc. According to an aspect, the system 300 can include a display component 302 that can be employed to convey information to a user. It can be appreciated that the pressure detection component 102 and the text entry component 104 can include functionality, as more fully described herein, for example, with regard to systems 100 and 200.

The pressure detection component 102 can detect an amount of pressure applied by a user, for example on a touch screen or a key. The text entry corresponding to the amount of pressure applied can be determined by the pressure detection component 102. Further, the selected text entry can be displayed to the user by the display component 302. The display component 302 can include most any audio-visual means to convey the selected text entry to the user, such as, but not limited to, a monitor, a touch screen, a speakerphone, etc. According to one aspect, the display component 302 can display the currently selected text based on the current pressure applied by the user on a display screen. The display component 302 can change the display text when a change in pressure is determined by the pressure detection component 102.

According to another aspect, the display component 302 can display the currently selected text along with one or more text entry options that can be selected when the applied pressure is increased or decreased. Thus, a user can easily identify a desired text option and accordingly adjust the applied pressure to select it. It can be appreciated that the display component 302 can employ most any technique to highlight the currently selected option and/or differentiate the current selection from the available options.

As an example, a user can employ a reduced set of keys on a cellular phone to enter text. As the pressure on a key is changed, a different character can be selected. The pressure detection component 102 can receive data associated with the pressure applied by the user and can determine a character associated with the applied pressure. The display component 302 can display the selected character on a screen of the cellular phone. Additionally or alternately, the display component 302 can generate an audio output to convey information associated with the selection through a speaker on the cellular phone. Further, the display component 302 can also display on the screen one or more characters that can be selected by the user by reducing the applied pressure and one or more characters that can be selected by the user by increasing the applied pressure. The user can adjust the applied pressure until a desired character is selected and then release pressure to enter the selected character. The pressure detection component 102 can determine that the user has released pressure and the currently selected character can be entered by the text entry component 104.

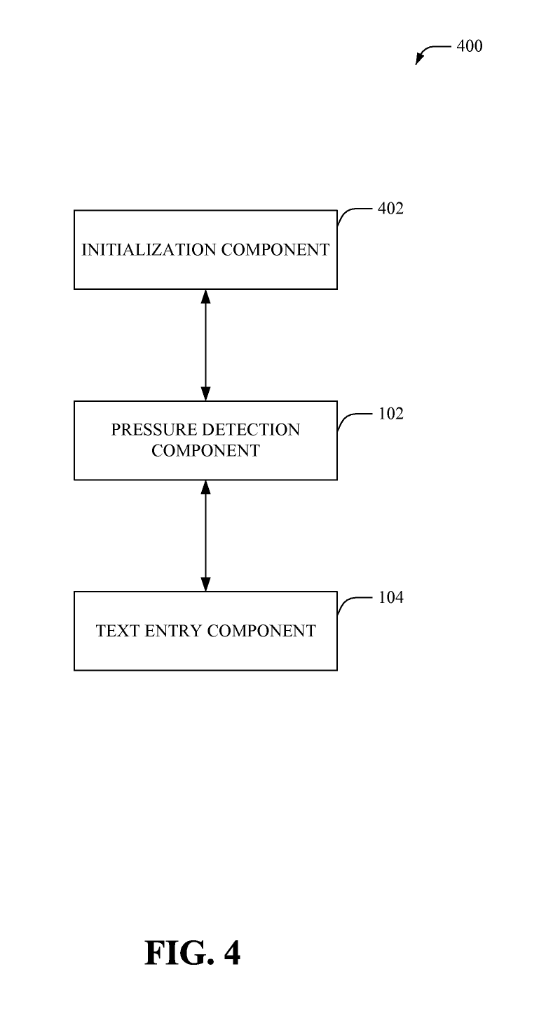

Referring now to FIG. 4, there illustrated is an example system 400 that can select between different options based on the amount of pressure exerted on a sensor located on an electronic device, according to an aspect of the subject innovation. The electronic device can include, most any device such as, a cellular telephone, a telephone, an SIP phone, a WLL station, a PDA, a battery operated handheld device, computing device, or other processing device, a portable media player, a portable media recorder, a camera, a laptop, an ATM, a personal computer, etc. The system 400 can facilitate reducing the size of the electronic device, a keypad on the electronic device and/or a display screen on the electronic device, since a user can select between multiple characters (or options) by employing a single key. It can be appreciated that the key can be a physical button on the keypad and/or an icon on a touch screen. Further, system 400 can include the pressure detection component 102 and text entry component 104, which can each include their respective functionality, as more fully described herein, for example, with regard to systems 100, 200 and 300.

An initialization component 402 can also be included in system 400 that can be employed to perform an initial setup. The initial setup can customize pressure thresholds for a particular user. As an example, the pressure detection component 102 can select a particular character when the pressure applied by user on the sensor lies within a particular range of pressure. A user via the initialization component 402 can customize the range of pressure. According to an aspect, the initialization component 402 can receive an explicit threshold value from a user. Thus, when the pressure applied to a key is less than the threshold value a particular character associated with the key can be selected for text entry and when the applied pressure is greater than or equal to the threshold value, another character associated with the key can be selected. It can be appreciated that multiple thresholds can be specified by a user to enable selection of multiple characters by employing the key.

According to another aspect, the initialization component 402 can determine a pressure range for a character associated with a key by requesting the user to apply a desired force on the key that will be employed to select a specific character. For example, the initialization component 402 can display a message on the screen, such as, but not limited to, “Press key to set a pressure value for ‘A’”. The pressure detection component 102 can determine the amount of pressure applied and associate the determined value of pressure with character ‘A’. Similarly, the initialization component 402 can request the user to press the key with a different amount of pressure to associate a different pressure value or range for each character that can be entered by employing the key.

As an example, a key, such as that on a mobile phone, can represent four characters ‘a’, ‘b’, ‘c’, and ‘d’. According to one aspect, the initialization component 402 can request the user to enter a threshold value for each character. It can be appreciated that a range of pressure values can also be requested by the initialization component 402. According to another aspect, the initialization component 402 can display a message, such as, “Press key to initialize pressure associated with character ‘a’”. When the user has pressed the key, the pressure detection component 102 can determine the pressure value and assign the value to character ‘a’. Similarly, pressure values associated with characters ‘b’, ‘c’ and ‘d’ can be obtained. During regular operation, the desired characters can be selected (for example, by the pressure detection component 102) based on the pressure currently applied by the user. It can be appreciated that the initialization component 402 can employ different techniques to assign a pressure value (or range) to a character. Additionally or alternately to the techniques described supra, the initialization component 402 can request the user to press a key with a maximum pressure and/or with a minimum pressure and can determine pressure threshold values (or ranges) for each character associated with the key, for example by interpolation.

Typically, the pressure threshold data can be stored in a database (not shown). It will be appreciated that the database described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The database of the subject systems and methods is intended to comprise, without being limited to, these and any other suitable types of memory.

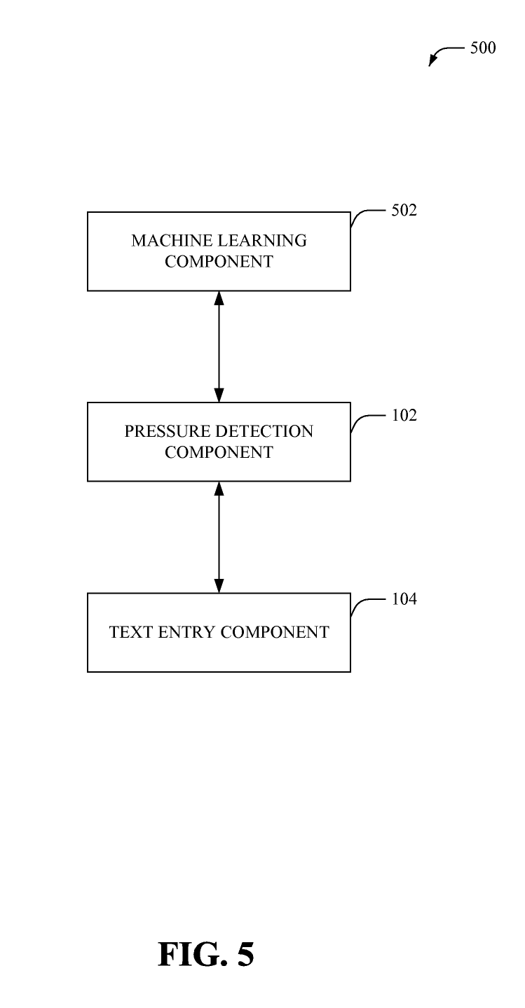

FIG. 5 illustrates an example system 500 that employs a machine learning component 502, which can facilitate automating one or more features in accordance with the subject innovation. It can be appreciated that the pressure detection component 102 and text entry component 104 can each include their respective functionality, as more fully described herein, for example, with regard to systems 100, 200, 300 and 400.

The subject innovation (e.g., in connection with selection of text) can employ various AI-based schemes for carrying out various aspects thereof. For example, a process for determining pressure thresholds for a particular user and/or selection of text based on applied pressure can be facilitated via an automatic classifier system and process. Moreover, where multiple characters can be represented by a key, the classifier can be employed to determine which character is selected for text entry.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when the pressure thresholds are generated, when they is regenerated (e.g., updated), which character is associated with each value of applied pressure. The criteria can include, but is not limited to, the amount of pressure applied by a user to select a character, information from errors, etc. According to one aspect, the machine learning component 502 can aggregate data from a plurality of users to automatically learn and perform the functions.

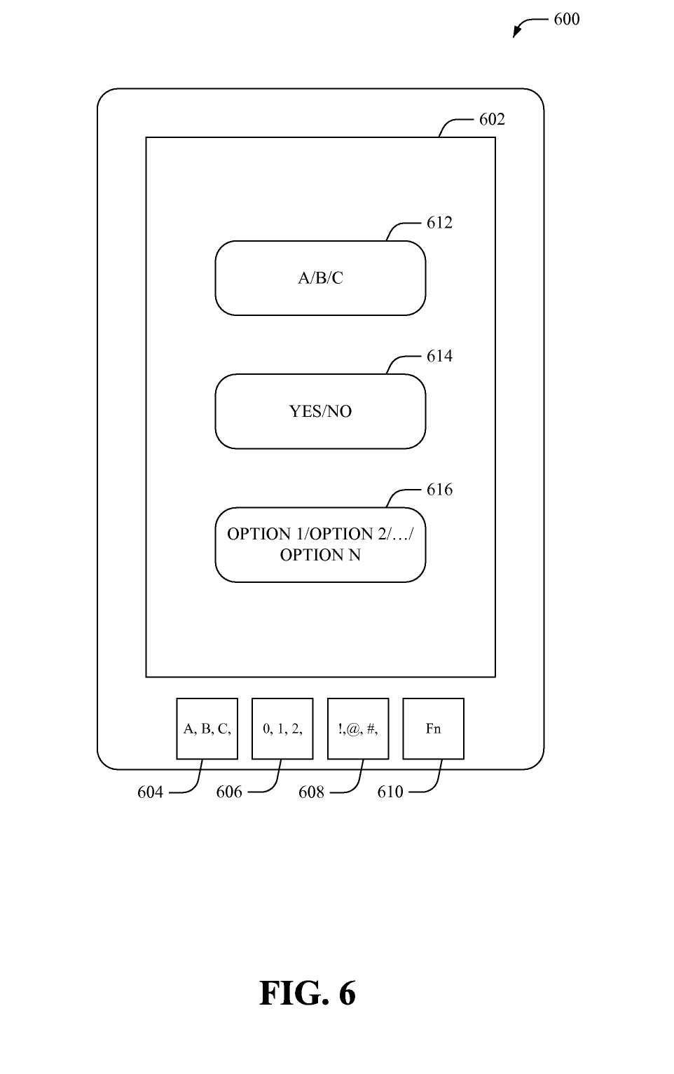

Referring now to FIG. 6, illustrated is an example electronic device 600 that can employ pressure analysis for text entry in accordance with an aspect of the disclosed subject matter. As described supra, the electronic device can be a mobile (e.g. cellular phone, portable media player, navigation system, etc.) or stationary device (e.g. ATM, electronic kiosk, etc.). The device 600 can include a display screen 604 and/or multiple keys 604-610 that can be employed by a user to input information. It can be appreciated that although only one display screen and four keys are depicted in FIG. 6, one or more display screens and/or one or more keys can be employed. Additionally, it can be appreciated that the display screen 602 can be a touch screen that can include multiple icons 612-616 for text entry (and/or selection).

As illustrated in FIG. 6, each key 604-610 can be employed to enter multiple characters and/or perform multiple functions. The selection of the character to be entered and/or function to be performed can be determined based on the pressure applied on the key. Specifically, a pressure sensitive sensor (e.g. sensors 202-206 in FIG.2) can be located beneath each key 604-610. The sensor can collect data associated with the pressure applied to the key and accordingly a character can be selected. For example, key 604 can represent alphabets A-Z (or a subset of alphabets), key 606 can represent digits 0-9 (or a subset of digits), key 608 can represent a set of symbols (e.g. !, @, #, $, etc.) and/or key 610 can represent a set of functions (e.g. delete, end, home, tab, etc.). A user can select one of the alphabets by adjusting pressure applied on key 604 until the desired alphabet is selected. Similarly, the user can select a desired digit, symbol, or function by adjusting the pressure applied to key 606, 608, and 610 respectively. The currently selected character (digit, symbol, or function) can be displayed on the screen 602 and can be highlighted. Additionally, one or more characters (digits, symbols, or functions) that can be selected when pressure on the key is decreased or increased from the current applied pressure value are displayed on screen 602.

According to an aspect, display screen 602 can be a touch screen that can include one or more icons 612-616. The icons 612-616 can be employed to enter text and/or select an option (function) that can be entered as an input to the electronic device 600. As an example, icon 612 can represent alphabets A, B and C. It can be appreciated that icon 612 is not limited to represent three alphabets, and two or more alphabets can be represented by the icon 612. As an example, when the user touches the icon 612 lightly, ‘A’ is selected. To select ‘B’ the user can press the icon 612 slightly harder and to select ‘C’ the user can press icon 612 very firmly. The user can adjust the pressure on the icon 612 to change the selection. Once the user is satisfied with the current selection, the user can release pressure so that the current selection can be entered.

As another example, icon 614 can be employed to enter a positive or negative confirmation. The user can touch the icon 614 lightly to indicate a positive response (Yes) or touch the icon 614 firmly to indicate a negative response (No). The device 600 senses the pressure on the icon 614 and determines whether the pressure applied by the user is greater than a predetermined threshold. If the pressure is greater than predetermined threshold, ‘No’ can be entered, else ‘Yes’ can be entered. The user can view the current selection on the screen 602. If the current selection is desired, the user can release pressure so that the current selection is entered; else, the user can adjust the pressure applied to icon 614 until the current selection is changed to a desired response.

In yet another example, the user can change the pressure applied on icon 616 to select between multiple options, OPTION 1 to OPTION N (where N can be a natural number from zero to infinity). The multiple options can be text entries, for example commonly used words utilized while writing a text message or can be multiple functions that can be performed when selected, for example, send message, delete message, store message, etc. Further, it can be appreciated that icons 612-616 and/or keys 604-610 can be employed to select between words, sentences, numbers and the like for text entry and/or to select between functions that can be performed by the device 600 based on the pressure exerted on them.

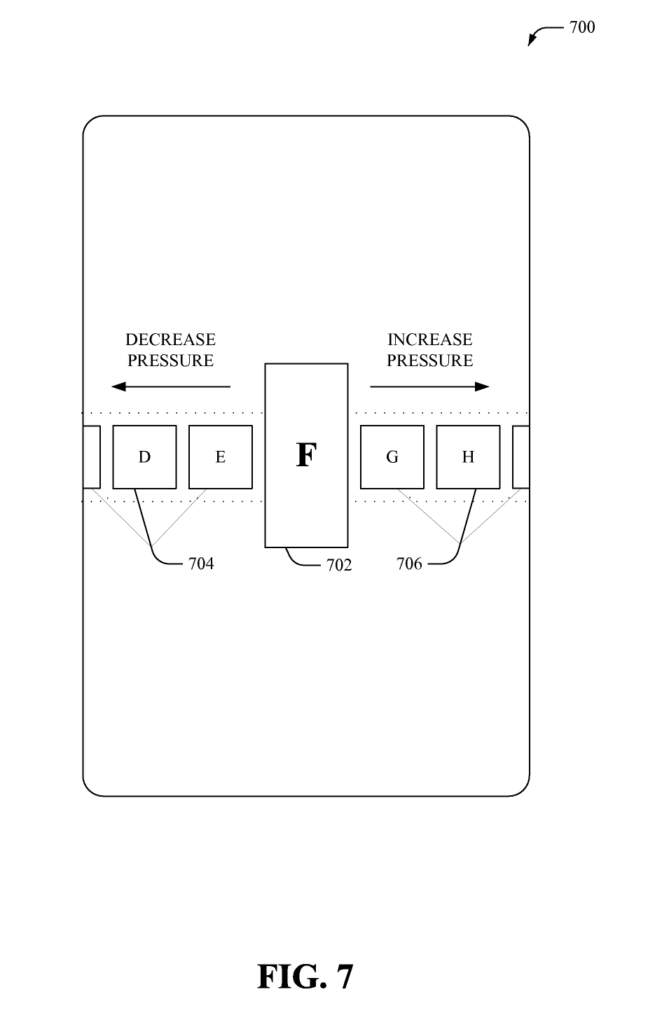

Referring to FIG. 7, illustrated is an example display 700 that can be employed to view a current selection based on the applied pressure, according to an aspect of the disclosed subject innovation. Display 700 can be employed by most any electronic device for text selection, such as, but not limited to, a cellular phone, a media player, a media recorder, a laptop, a desktop computer, an ATM, a kiosk, etc. In one example, the display 700 can be a touch screen display. Further, it can be appreciated that although a selection of alphabets is depicted in FIG. 7, the display can enable a user to view a selection of numbers, digits, symbols, words and the like or a combination thereof that are associated with the pressed key.

In particular, the user can press a key on the electronic device to select a character, for example an alphabet, represented by the key. A key can represent one or more characters. Typically, a key can be a physical button on the electronic device and/or an icon (e.g. icon 702) on a touch screen (e.g. display 700). Based on the pressure applied by the user, a character associated with the applied pressure is selected. A current selection 702 can be displayed to a user on the display 700. In one aspect, the current selection 702 can be highlighted so that the user can easily identify the selection 702 and adjust the applied pressure if the current selection 702 is not desired. Further, a set of characters 704 that can be selected by decreasing the applied pressure can be displayed to the user. Additionally or alternately, a set of characters 706 that can be selected by increasing the applied pressure can also be displayed to the user. When the selected character 702 is not desired, the user can view the set of characters 704-706 and make a quick and informed decision to adjust the applied pressure accordingly. Typically, the selected character 702 can be updated based the change in applied pressure. When the selected character 702 is desired by the user, the user can release pressure from the key and the selected character can be entered. In one aspect, options 702-706 can be overlaid on an existing screen when the key is pressed.

As an example, FIG. 7 illustrates a selection of alphabets wherein ‘F’ is the current selection 702. Typically, the selected alphabet can be highlighted so that the user can easily differentiate between the currently selected alphabet 702 and the unselected alphabets 707-706. When the user releases pressure, the currently selected alphabet ‘F’ will be entered into the device. For example, the letter ‘F’ can be typed on the screen 700. Further, if the user decreases the applied pressure, letter ‘E’ can be selected. With a further decrease in applied pressure, letter ‘D’ can be selected and so on. Similarly, letters ‘G’, ‘H’, and so on can be selected if the user increases the applied pressure.

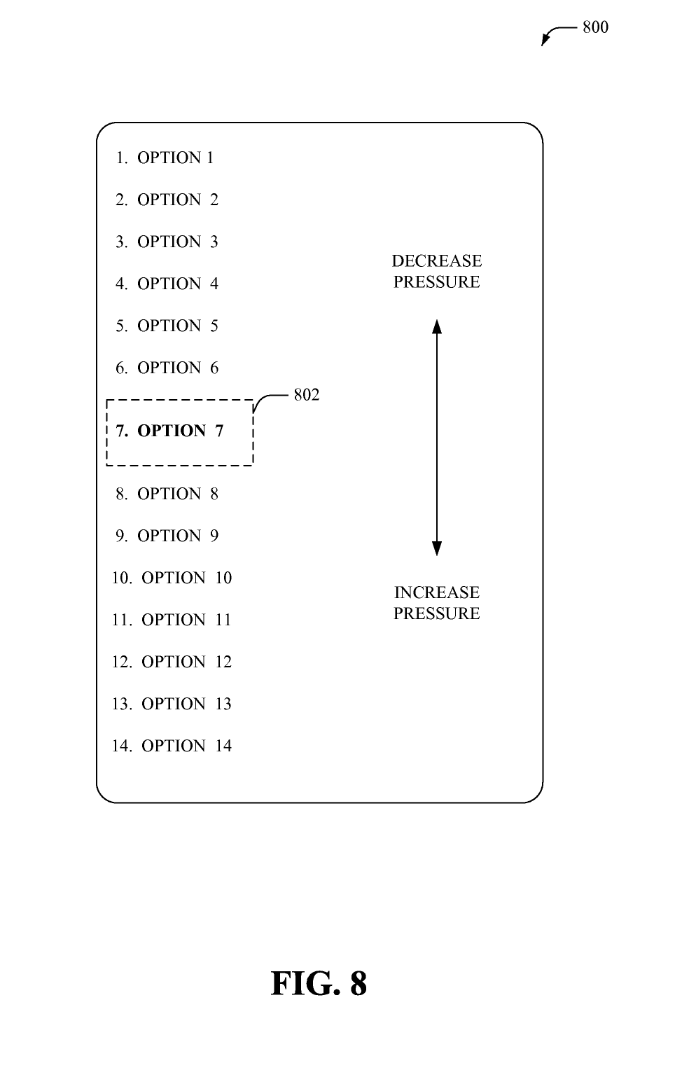

FIG. 8 illustrates an example display 800 that can be employed to view a currently selected option based on pressure applied to a key in accordance with an aspect of the disclosed subject innovation. Specifically, a user can be enabled to scroll through multiple options by changing the pressure applied to a key. Typically, a user can employ a finger to press the key. Alternately, the key can be pressed by a stylus or similar object.

As an example, display 800 can depict fourteen options (OPTION 1-OPTION 14) that can be represented by a single key (not shown). Based on the pressure applied on the key an option is selected and the selected option can be highlighted, for example by creating a box around the selected option, as shown at 802. The selected option can be modified by increasing or decreasing the pressure applied on the key. When the desired option is selected, the user can stop pressing the key and the selected option can be entered.

It can be appreciated that the options can include letters, digits, words, sentences, numbers and a combination thereof. Additionally, the options can include a function to be performed by an electronic device. For example, options 1-14 can be options in a cellular phone menu, such as, but not limited to, ‘Create message’, ‘Check voicemail, ‘View messages’, ‘Dial’, etc. The user can browse through multiple options by changing the pressure applied to a key on the cellular phone. The current selection can be highlighted and when the current selection is desired, the user can release pressure from the key. When the applied pressure is released, the currently selected option can be performed. For example, if a ‘View received messages’ option is selected, the user can be directed to a message inbox and a list of received messages can be displayed on screen 800.

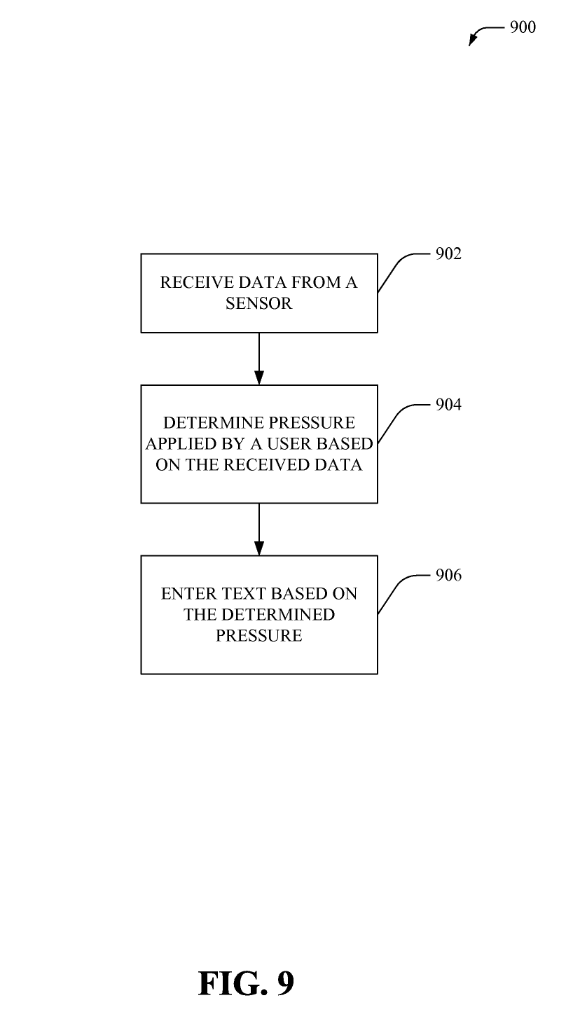

FIGS. 9-11 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 9, illustrated is an example methodology 900 that can be employed to facilitate text entry based on an amount of pressure applied to a key on an electronic device in accordance with an aspect of the subject innovation. According to an aspect, one or more pressure sensors can be located on the key. At 902, data associated with a user's touch can be collected from the one or more pressure sensors. At 904, the amount of pressure applied by the user can be determined based on the received data. Typically, a character or text can be associated with a particular pressure value (or range). The character or text associated with the pressure currently applied by the user can be determined. At 906, the determined text can be entered based on the applied pressure.

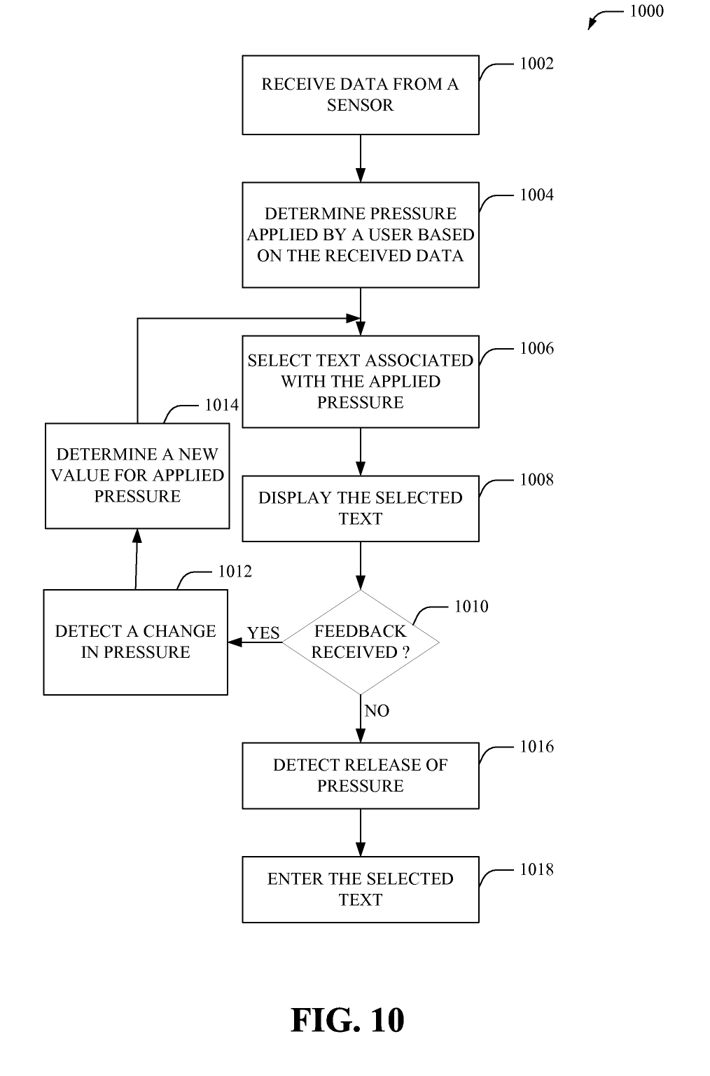

FIG. 10 is an illustration of an example methodology 1000 that can facilitate selection of text based on the pressure data collected by one or more sensors in accordance with an aspect of the system. At 1002, data can be received from a pressure sensor. According to an aspect, the pressure sensor can be located on a key on an electronic device, such as, but not limited to, a cellular phone, an MP3 player, a GPS navigator, a PDA, a laptop, an ATM, a gaming module, a radio player, a media recorder, an electronic kiosk, or a combination thereof. Typically, the key can be a physical button on the device and/or an icon on a touch screen. It can be appreciated that the key can be employed to input information to the device and can be located on a remote device.

At 1004, the pressure applied by a user on the key can be determined based on the received data. At 1006, text associated with the determined pressure can be selected. Typically, the received pressure data can be analyzed and compared to one or more predetermined pressure thresholds. According to an aspect, if the input pressure is less than the predefined pressure threshold, a particular character(s) can be selected; else, another character(s) can be selected. As an example, the predefined threshold can be set by the device manufacturer, customized by a user or automatically determined. Further, it can be appreciated that the one or more thresholds can be set based on the number of characters assigned to the key. At 1008, the selected text can be displayed to the user, for example, via a display screen, touch screen, monitor etc. Moreover, the selected text can be highlighted, such that, the user can easily identify the selection. Additionally, one or more characters, which can be selected when pressure on the key is decreased or increased from the current pressure value, can be also displayed.

The user can adjust pressure applied to the key until a desired character is selected. At 1010, it can be determined if feedback is received from the user. According to an aspect, the user feedback can include an increase or decrease in pressure applied on the key. When feedback is received, a change in pressure applied to the key can be detected, as shown at 1012. At 1014, a new value of applied pressure can be determined. Text associated with the new value can be selected and displayed to the user (as shown at 1006-1008). At 1010, a determination can be made if feedback is received from the user and if so, acts 1012-1010 can be repeated until the user is satisfied with the current selection. When the user is satisfied with the currently selected text, the user can release pressure from the key. At 1016, a release in applied pressure can be detected and at 1018, the currently selected text can be entered, for example, typed on a screen.

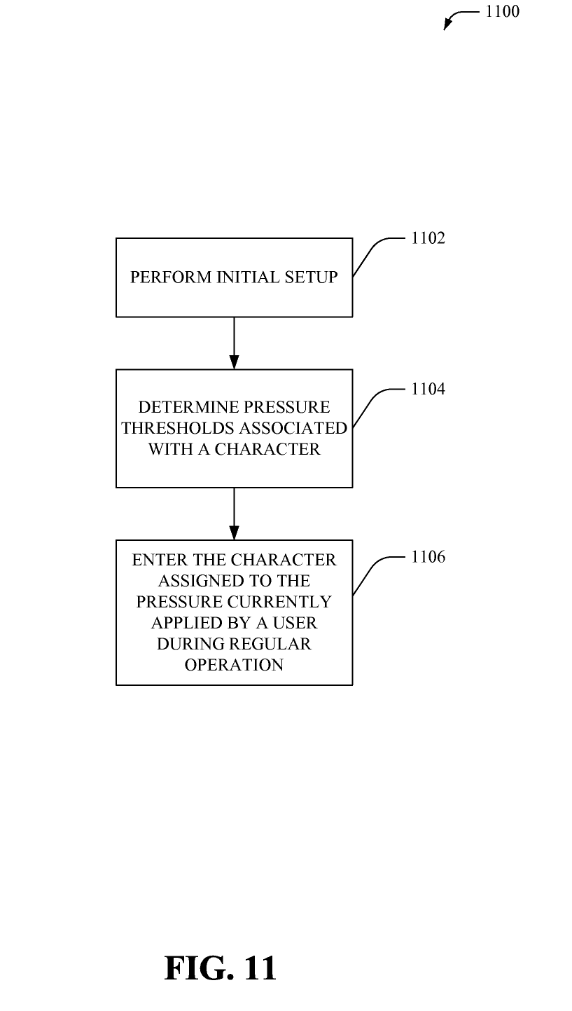

Referring now to FIG. 11, there illustrated is an example methodology 1100 that can be employed to customize pressure thresholds for a particular user, according to an aspect of the disclosed subject innovation. At 1102, an initial setup can be performed. At 1104, a pressure threshold value associated with a specific character can be determined. According to an aspect, one or more explicit threshold values can be received from a user that can be assigned to one or more characters that are associated with a key. It can be appreciated that various techniques can be employed to assign a pressure threshold value (or range) to a character, such as, the user can be requested to press a key with a maximum pressure and/or with a minimum pressure and pressure threshold values (or ranges) for each character associated with the key can be determined, for example by interpolation. At 1106, the character assigned to the pressure currently applied by a user can be entered during regular operation.

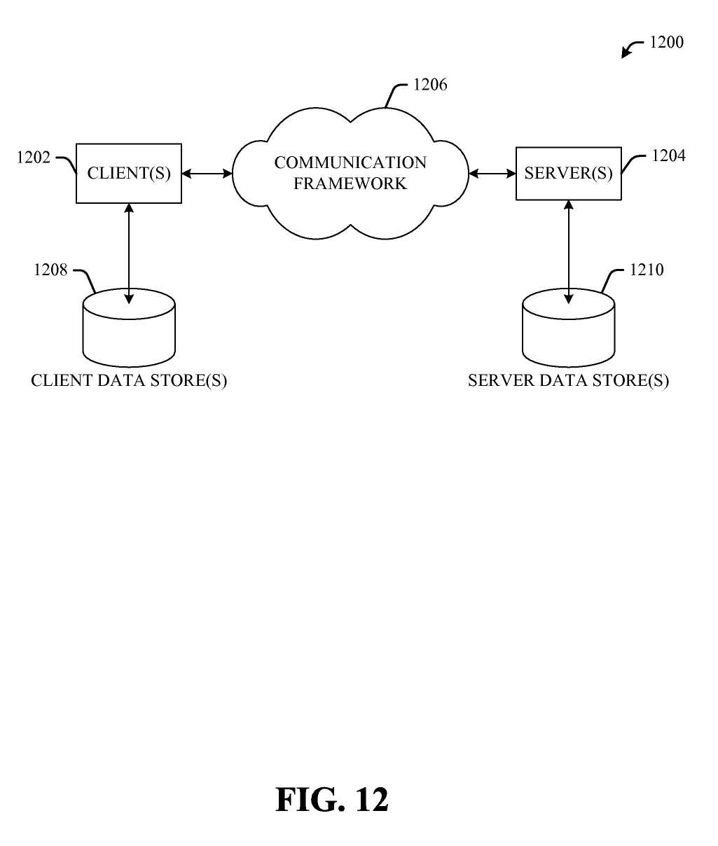

FIG. 12 illustrates a schematic block diagram of a computing environment 1200 that facilitates text entry with different pressure levels in accordance with the subject specification. The system 1200 includes one or more client(s) 1202. The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware and/or software (e.g., threads, processes, computing devices). The servers 1204 can house threads to perform transformations by employing the specification, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

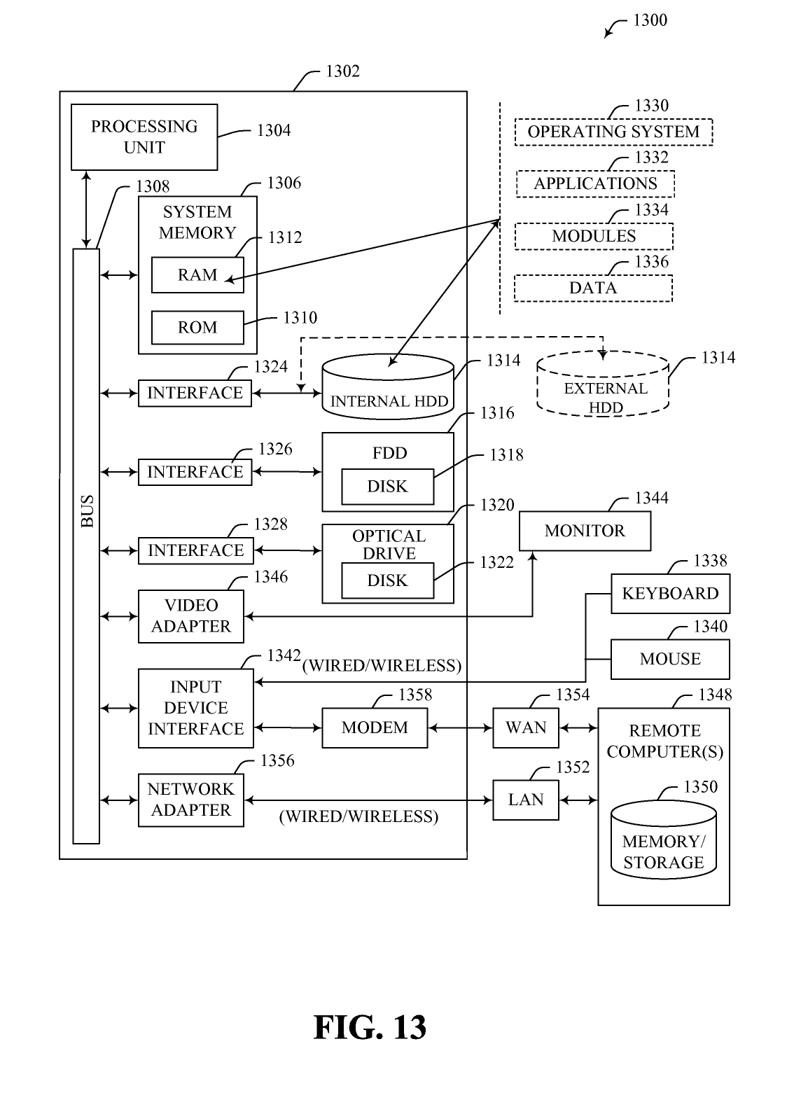

Referring now to FIG. 13, there is illustrated a block diagram of a computer operable to execute the disclosed architecture. In order to provide additional context for various aspects of the subject specification, FIG. 13 and the following discussion are intended to provide a brief, general description of a suitable computing environment 1300 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the example environment 1300 for implementing various aspects of the specification includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the specification can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are example and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that that facilitates text entry based on contact pressure, comprising:
a pressure detection component that selects text based on an amount of pressure applied to a key; and
a text entry component that enters the selected text.

2. The system of claim 1, further comprising, one or more sensors located on the key that collect data associated with pressure applied to the key.

3. The system of claim 1, wherein, the pressure detection component determines the amount of pressure applied to the key.

4. The system of claim 1, further comprising, a display component that displays the selected text on a screen.

5. The system of claim 4, wherein, the display component displays one or more characters that will be selected when the applied pressure is changed.

6. The system of claim 1, further comprising, an initialization component that is employed to assign one or more characters associated with the key to a pressure threshold value.

7. The system of claim 1, wherein, the pressure detection component compares the applied pressure amount to a predetermined threshold to select text.

8. The system of claim 1, wherein, the pressure detection component monitors the pressure applied to the key and updates the selected text when a change in pressure is detected.

9. The system of claim 1, wherein, the pressure detection component determines a release in pressure on the key, the selected text is entered when the pressure is released.

10. The system of claim 1, wherein, the text entry component performs an action based on the selected text.

11. A method that employs pressure analysis for text entry, comprising:
determining a value of pressure applied on a key;
identifying a predetermined range of pressure that the applied value lies within; and
selecting one or more characters assigned to the predetermined range of pressure values.

12. The method of claim 11, further comprising, detecting a change in the value of pressure applied on the key.

13. The method of claim 12, further comprising, updating the one or more selected characters based on the change in the value of pressure.

14. The method of claim 11, further comprising, displaying the one or more characters on a screen.

15. The method of claim 11, further comprising, customizing the predetermined range of pressure during an initial setup.

16. A system that facilitates selection of text based on pressure applied to a key on an electronic device, comprising:
means for receiving data associated with pressure applied on a key;
means for determining an amount of pressure exerted on the key based on the received data; and
means for entering text associated with the determined amount of pressure.

17. The system of claim 16, further comprising, means for comparing the amount of pressure with a predetermined threshold.

18. The system of claim 16, further comprising, means for adjusting the pressure applied until desired text is entered.

19. The system of claim 16, further comprising, means for updating a selected text entry based on a change in the pressure applied.

20. The system of claim 19, further comprising, means for displaying the selected text entry to a user.
